(19) United States
(12) Patent Application Publication
(10) Pub. No.: US 2017/0329607 A1
(43) Pub. Date: Nov. 16, 2017

(54) HAZARD AVOIDANCE IN A MULTI-SLICE PROCESSOR

(71) Applicant: International Business Machines Corporation, Armonk, NY (US)

(72) Inventors: RICHARD J. EICKEMEYER, ROCHESTER, MN (US); JOHN B. GRISWELL, JR., AUSTIN, TX (US); DAVID S. LEVITAN, AUSTIN, TX (US); BRIAN W. THOMPTO, AUSTIN, TX (US)

(21) Appl. No.: 15/155,327

(22) Filed: May 16, 2016

(51) Int. Cl. G06F 9/30

(52) U.S. Cl. CPC G06F 9/30043; G06F 9/30196

(57) ABSTRACT

Hazard avoidance in a multi-slice processor including adding, to a hazard table, an entry for an effective address, wherein the entry comprises an instruction tag (ITAG) offset for the effective address; fetching, by an instruction fetch unit, a processor instruction from a memory location using the effective address; determining that the hazard table includes the entry for the effective address; retrieving, from the hazard table, the ITAG offset for the effective address; identifying a prior internal operation (TOP) using the ITAG offset; and decoding the processor instruction into a load IOP with a dependency on the prior IOP.

### BACKGROUND

### Field of the Invention

The field of the invention is data processing, or, more specifically, methods, apparatus, and products for hazard avoidance in a multi-slice processor.

### Description Of Related Art

The development of the EDVAC computer system of 1948 is often cited as the beginning of the computer era. Since that time, computer systems have evolved into extremely complicated devices. Today's computers are much more sophisticated than early systems such as the EDVAC. Computer systems typically include a combination of hardware and software components, application programs, operating systems, processors, buses, memory, input/output devices, and so on. As advances in semiconductor processing and computer architecture push the performance of the computer higher and higher, more sophisticated computer software has evolved to take advantage of the higher performance of the hardware, resulting in computer systems today that are much more powerful than just a few years ago.

One area of computer system technology that has advanced is computer processors. As the number of computer systems in data centers and the number of mobile computing devices has increased, the need for more efficient computer processors has also increased. Speed of operation and power consumption are just two areas of computer processor technology that affect efficiency of computer processors.

### SUMMARY

Methods and apparatus for hazard avoidance in a multi-slice processor are disclosed in this specification. Hazard avoidance in a multi-slice processor includes adding, to a hazard table, an entry for an effective address, wherein the entry comprises an instruction tag (ITAG) offset for the effective address; fetching, by an instruction fetch unit, a processor instruction from a memory location using the effective address; determining that the hazard table includes the entry for the effective address; retrieving, from the hazard table, the ITAG offset for the effective address; identifying a prior internal operation (TOP) using the ITAG offset; and decoding the processor instruction into a load IOP with a dependency on the prior IOP.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 sets forth a block diagram of an example system configured for hazard avoidance in a multi-slice processor according to embodiments of the present invention.

FIG. 2 sets forth a block diagram of a portion of a multi-slice processor according to embodiments of the present invention.

FIG. 3 sets forth a block diagram of a portion of a multi-slice processor according to embodiments of the present invention.

FIG. 4 sets forth a flow chart illustrating an exemplary method for hazard avoidance in a multi-slice processor according to embodiments of the present invention.

FIG. 5 sets forth a flow chart illustrating an exemplary method for hazard avoidance in a multi-slice processor according to embodiments of the present invention.

FIG. 6 sets forth a flow chart illustrating an exemplary method for hazard avoidance in a multi-slice processor according to embodiments of the present invention.

FIG. 7 sets forth a flow chart illustrating an exemplary method for hazard avoidance in a multi-slice processor according to embodiments of the present invention.

### DETAILED DESCRIPTION

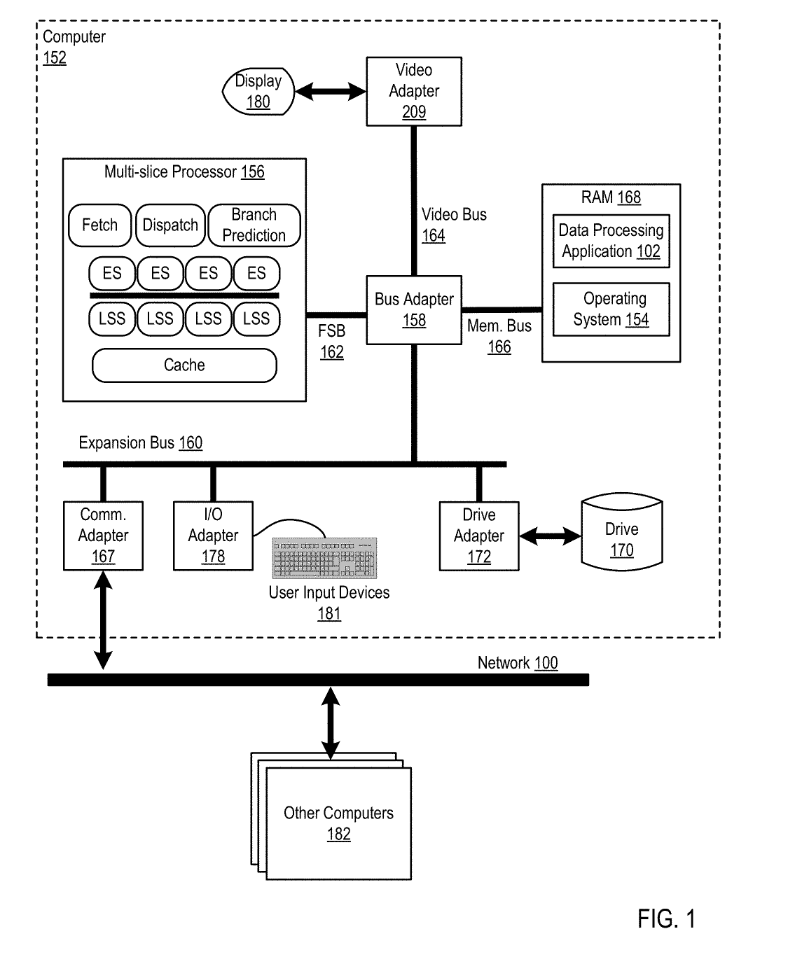

Exemplary methods and apparatus for hazard avoidance in a multi-slice processor in accordance with the present invention are described with reference to the accompanying drawings, beginning with FIG. 1. FIG. 1 sets forth a block diagram of an example system configured for hazard avoidance in a multi-slice processor according to embodiments of the present invention. The system of FIG. 1 includes an example of automated computing machinery in the form of a computer (152).

The computer (152) of FIG. 1 includes at least one computer processor (156) or ‘CPU’ as well as random access memory (168) (‘RAM’) which is connected through a high speed memory bus (166) and bus adapter (158) to processor (156) and to other components of the computer (152).

The example computer processor (156) of FIG. 1 may be implemented as a multi-slice processor. The term ‘multi-slice’ as used in this specification refers to a processor having a plurality of similar or identical sets of components, where each set may operate independently of all the other sets or in concert with the one or more of the other sets. The multi-slice processor (156) of FIG. 1, for example, includes several execution slices (‘ES’) and several load/store slices (‘LSS’)—where load/store slices may generally be referred to as load/store units. Each execution slice may be configured to provide components that support execution of instructions: an issue queue, general purpose registers, a history buffer, an arithmetic logic unit (including a vector scalar unit, a floating point unit, and others), and the like. Each of the load/store slices may be configured with components that support data movement operations such as loading of data from cache or memory or storing data in cache or memory. In some embodiments, each of the load/store slices includes a data cache. The load/store slices are coupled to the execution slices through a results bus. In some embodiments, each execution slice may be associated with a single load/store slice to form a single processor slice. In some embodiments, multiple processor slices may be configured to operate together.

The example multi-slice processor (156) of FIG. 1 may also include, in addition to the execution and load/store slices, other processor components. In the system of FIG. 1, the multi-slice processor (156) includes fetch logic, dispatch logic, and branch prediction logic. Further, although in some embodiments each load/store slice includes cache memory, the multi-slice processor (156) may also include cache accessible by any or all of the processor slices.

Although the multi-slice processor (156) in the example of FIG. 1 is shown to be coupled to RAM (168) through a front side bus (162), a bus adapter (158) and a high speed memory bus (166), readers of skill in the art will recognize that such configuration is only an example implementation. In fact, the multi-slice processor (156) may be coupled to other components of a computer system in a variety of configurations. For example, the multi-slice processor (156) in some embodiments may include a memory controller configured for direct coupling to a memory bus (166). In some embodiments, the multi-slice processor (156) may support direct peripheral connections, such as PCIe connections and the like.

Stored in RAM (168) in the example computer (152) is a data processing application (102), a module of computer program instructions that when executed by the multi-slice processor (156) may provide any number of data processing tasks. Examples of such data processing applications may include a word processing application, a spreadsheet application, a database management application, a media library application, a web server application, and so on as will occur to readers of skill in the art. Also stored in RAM (168) is an operating system (154). Operating systems useful in computers configured for operation of a multi-slice processor according to embodiments of the present invention include UNIX™, Linux™, Microsoft Windows™, AIX™, IBM's z/OS™, and others as will occur to those of skill in the art. The operating system (154) and data processing application (102) in the example of FIG. 1 are shown in RAM (168), but many components of such software typically are stored in non-volatile memory also, such as, for example, on a disk drive (170).

The computer (152) of FIG. 1 includes disk drive adapter (172) coupled through expansion bus (160) and bus adapter (158) to processor (156) and other components of the computer (152). Disk drive adapter (172) connects non-volatile data storage to the computer (152) in the form of disk drive (170). Disk drive adapters useful in computers configured for operation of a multi-slice processor according to embodiments of the present invention include Integrated Drive Electronics (‘IDE’) adapters, Small Computer System Interface (‘SCSI’) adapters, and others as will occur to those of skill in the art. Non-volatile computer memory also may be implemented for as an optical disk drive, electrically erasable programmable read-only memory (so-called ‘EEPROM’ or ‘Flash’ memory), RAM drives, and so on, as will occur to those of skill in the art.

The example computer (152) of FIG. 1 includes one or more input/output (‘I/O’) adapters (178). I/O adapters implement user-oriented input/output through, for example, software drivers and computer hardware for controlling output to display devices such as computer display screens, as well as user input from user input devices (181) such as keyboards and mice. The example computer (152) of FIG. 1 includes a video adapter (209), which is an example of an I/O adapter specially designed for graphic output to a display device (180) such as a display screen or computer monitor. Video adapter (209) is connected to processor (156) through a high speed video bus (164), bus adapter (158), and the front side bus (162), which is also a high speed bus.

The exemplary computer (152) of FIG. 1 includes a communications adapter (167) for data communications with other computers (182) and for data communications with a data communications network (100). Such data communications may be carried out serially through RS-232 connections, through external buses such as a Universal Serial Bus (‘USB’), through data communications networks such as IP data communications networks, and in other ways as will occur to those of skill in the art. Communications adapters implement the hardware level of data communications through which one computer sends data communications to another computer, directly or through a data communications network. Examples of communications adapters useful in computers configured for operation of a multi-slice processor according to embodiments of the present invention include modems for wired dial-up communications, Ethernet (IEEE 802.3) adapters for wired data communications, and 802.11 adapters for wireless data communications.

The arrangement of computers and other devices making up the exemplary system illustrated in FIG. 1 are for explanation, not for limitation. Data processing systems useful according to various embodiments of the present invention may include additional servers, routers, other devices, and peer-to-peer architectures, not shown in FIG. 1, as will occur to those of skill in the art. Networks in such data processing systems may support many data communications protocols, including for example TCP (Transmission Control Protocol), IP (Internet Protocol), HTTP (HyperText Transfer Protocol), WAP (Wireless Access Protocol), HDTP (Handheld Device Transport Protocol), and others as will occur to those of skill in the art. Various embodiments of the present invention may be implemented on a variety of hardware platforms in addition to those illustrated in FIG. 1.

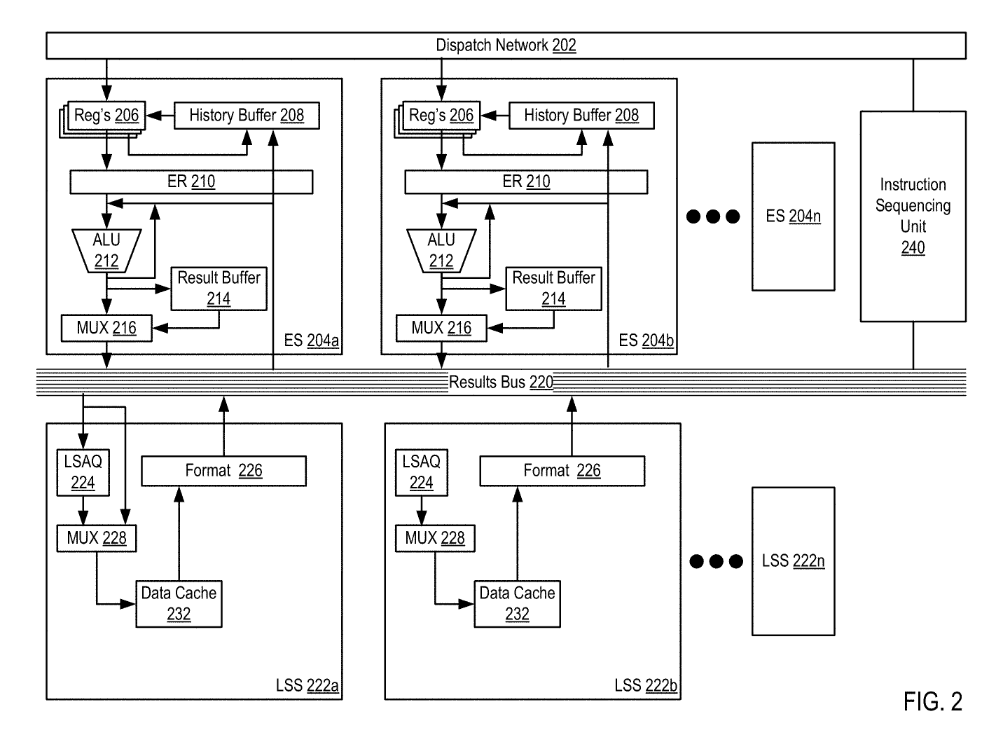

For further explanation, FIG. 2 sets forth a block diagram of a portion of a multi-slice processor according to embodiments of the present invention. The multi-slice processor in the example of FIG. 2 includes a dispatch network (202). The dispatch network (202) includes logic configured to dispatch instructions for execution among execution slices.

The multi-slice processor in the example of FIG. 2 also includes a number of execution slices (204a, 204b-204n). Each execution slice includes general purpose registers (206) and a history buffer (208). The general purpose registers and history buffer may sometimes be referred to as the mapping facility, as the registers are utilized for register renaming and support logical registers.

The general purpose registers (206) are configured to store the youngest instruction targeting a particular logical register and the result of the execution of the instruction. A logical register is an abstraction of a physical register that enables out-of-order execution of instructions that target the same physical register.

When a younger instruction targeting the same particular logical register is received, the entry in the general purpose register is moved to the history buffer, and the entry in the general purpose register is replaced by the younger instruction. The history buffer (208) may be configured to store many instructions targeting the same logical register. That is, the general purpose register is generally configured to store a single, youngest instruction for each logical register while the history buffer may store many, non-youngest instructions for each logical register.

Each execution slice (204) of the multi-slice processor of FIG. 2 also includes an execution reservation station (210). The execution reservation station (210) may be configured to issue instructions for execution. The execution reservation station (210) may include an issue queue. The issue queue may include an entry for each operand of an instruction. The execution reservation station may issue the operands for execution by an arithmetic logic unit or to a load/store slice (222a, 222b, 222n) via the results bus (220).

The arithmetic logic unit (212) depicted in the example of FIG. 2 may be composed of many components, such as add logic, multiply logic, floating point units, vector/scalar units, and so on. Once an arithmetic logic unit executes an operand, the result of the execution may be stored in the result buffer (214) or provided on the results bus (220) through a multiplexer (216).

The results bus (220) may be configured in a variety of manners and be of composed in a variety of sizes. In some instances, each execution slice may be configured to provide results on a single bus line of the results bus (220). In a similar manner, each load/store slice may be configured to provide results on a single bus line of the results bus (220). In such a configuration, a multi-slice processor with four processor slices may have a results bus with eight bus lines—four bus lines assigned to each of the four load/store slices and four bus lines assigned to each of the four execution slices. Each of the execution slices may be configured to snoop results on any of the bus lines of the results bus. In some embodiments, any instruction may be dispatched to a particular execution unit and then by issued to any other slice for performance. As such, any of the execution slices may be coupled to all of the bus lines to receive results from any other slice. Further, each load/store slice may be coupled to each bus line in order to receive an issue load/store instruction from any of the execution slices. Readers of skill in the art will recognize that many different configurations of the results bus may be implemented.

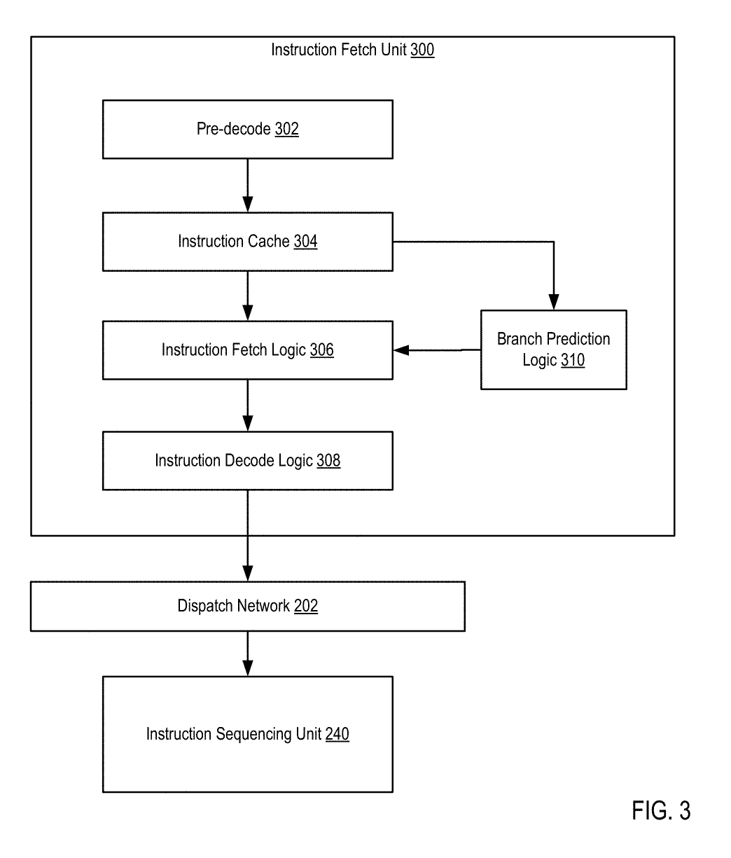

The multi-slice processor in the example of FIG. 2 also includes a number of load/store slices (222a, 222b-222n). Each load/store slice includes a queue (224), a multiplexer (228), a data cache (232), and formatting logic (226), among other components described below with regard to FIG. 3. The queue receives load and store operations to be carried out by the load/store slice (222). The formatting logic (226) formats data into a form that may be returned on the results bus (220) to an execution slice as a result of a load or store instruction.

The example multi-slice processor of FIG. 2 may be configured for flush and recovery operations. A flush and recovery operation is an operation in which the registers (general purpose register and history buffer) of the multi-slice processor are effectively ‘rolled back’ to a previous state. The term ‘restore’ and ‘recover’ may be used, as context requires in this specification, as synonyms. Flush and recovery operations may be carried out for many reasons, including missed branch predictions, exceptions, and the like. Consider, as an example of a typical flush and recovery operation, that a dispatcher of the multi-slice processor dispatches over time and in the following order: an instruction A targeting logical register 5, an instruction B targeting logical register 5, and an instruction C targeting logical register 5. At the time instruction A is dispatched, the instruction parameters are stored in the general purpose register entry for logical register 5. Then, when instruction B is dispatched, instruction A is evicted to the history buffer (all instruction parameters are copied to the history buffer, including the logical register and the identification of instruction B as the evictor of instruction A), and the parameters of instruction B are stored in the general purpose register entry for logical register 5. When instruction C is dispatched, instruction B is evicted to the history buffer and the parameters of instruction C are stored in the general purpose register entry for logical register 5. Consider, now, that a flush and recovery operation of the registers is issued in which the dispatch issues a flush identifier matching the identifier of instruction C. In such an example, flush and recovery includes discarding the parameters of instruction C in the general purpose register entry for logical register 5 and moving the parameters of instruction B from the history buffer for instruction B back into the entry of general purpose register for logical register 5.

During the flush and recovery operation, in prior art processors, the dispatcher was configured to halt dispatch of new instructions to an execution slice. Such instructions may be considered either target or source instructions. A target instruction is an instruction that targets a logical register for storage of result data. A source instruction by contrast has, as its source, a logical register. A target instruction, when executed, will result in data stored in an entry of a register file while a source instruction utilizes such data as a source for executing the instruction. A source instruction, while utilizing one logical register as its source, may also target another logical register for storage of the results of instruction. That is, with respect to one logical register, an instruction may be considered a source instruction and with respect to another logical register, the same instruction may be considered a target instruction.

The multi-slice processor in the example of FIG. 2 also includes an instruction sequencing unit (240). While depicted as a single unit, each of the plurality of execution slices may include a respective instruction sequencing unit similar to instruction sequencing unit (240). Instruction sequencing unit (240) may take dispatched instructions and check dependencies of the instructions to determine whether all older instructions with respect to a current instruction have delivered, or may predictably soon deliver, results of these older instructions from which the current instruction is dependent so that the current instruction may execute correctly. If all dependencies to a current instruction are satisfied, then a current instruction may be determined to be ready to issue, and may consequently be issued—regardless of a program order of instructions as determined by an ITAG. Such issuance of instructions may be referred to as an “out-of-order” execution, and the multi-slice processor may be considered an out-of-order machine.

In some cases, a load/store unit receiving an issued instruction, such as a load/store slice, may not yet be able to handle the instruction, and the instruction sequencing unit (240) may keep the instruction queued until such time as the load/store slice may handle the instruction. After the instruction is issued, the instruction sequencing unit (240) may track progress of the instruction based at least in part on signals received from a load/store slice.

For further explanation, FIG. 3 sets forth a block diagram of another portion of a multi-slice processor according to embodiments of the present invention. The example multi-slice processor of FIG. 3 includes an instruction fetch unit (300) that includes a pre-decode logic (302) configured to retrieve instructions from memory, perform a preliminary decode of the instruction and store the pre-decoded instruction into an instruction cache (304).

The instruction fetch unit (300) also includes branch prediction logic (310). Branch prediction logic generally performs branch prediction for pre-decoded instructions and tracks various branch prediction statistics for executing and executed instructions. The branch prediction logic (310) may include or access various registers and storage that contain such branch prediction statistics. Examples of storage entities may include global branch history tables and the like.

The instruction fetch unit (300) also includes an instruction fetch logic (306). The instruction fetch logic (306) generally retrieves instructions from the instruction cache and provides the fetched instruction to instruction decode logic (308).

The example instruction decode logic (308) of FIG. 3 performs a final decode operation on the fetched instructions and provides the decoded instructions to the dispatch network (202). The dispatch network as described above, dispatches the decoded instructions among slices. Also operatively connected to the dispatch network (202) is the instruction sequencing unit (240).

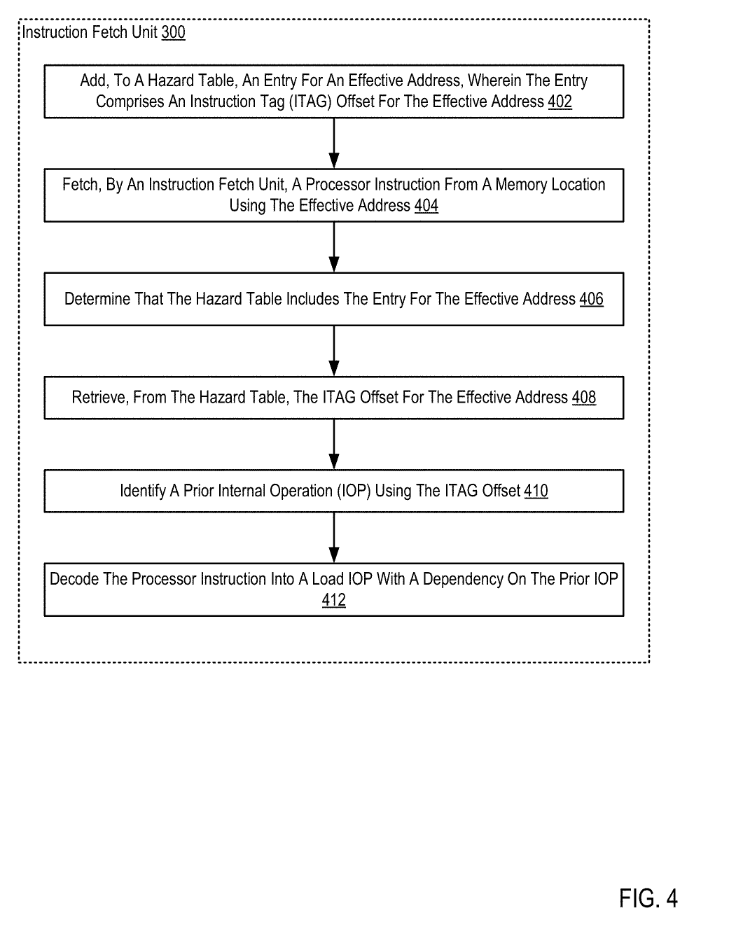

For further explanation, FIG. 4 sets forth a flow chart illustrating a further exemplary method for hazard avoidance in a multi-slice processor according to embodiments of the present invention. The method of FIG. 4 may be carried out by a multi-slice processor similar to that in the examples of FIGS. 1-3. The method of FIG. 4 includes adding (402), to a hazard table, an entry for an effective address, wherein the entry comprises an instruction tag (ITAG) offset for the effective address. Adding (402), to a hazard table, an entry for an effective address, wherein the entry comprises an instruction tag (ITAG) offset for the effective address may be carried out by receiving a flush indication comprising a flush ITAG and the ITAG offset; obtaining the effective address using the flush ITAG; and storing the ITAG offset keyed to the effective address in the hazard table.

The hazard table is a data structure implemented to avoid flushes caused by certain hazards, such as store-hit-load hazards. A store-hit-load hazard may occur in an out-of-order processing system when a load internal instruction (IOP) reads from a location in cache or from memory before the expected result data has been stored in that location. Once the hazard has been detected, a flush is initiated of the load instruction or all instructions after the store. The flush may cause the flushed instructions to be refetched by the instruction fetch unit. If the same set of instructions, including the load and store, are executed multiple times by the multi-slice processor, the same hazard may occur (and therefore the flush) each time the instructions are executed.

The hazard table enables the instruction fetch unit (300) to create a dependency tracked by the other elements in the multi-slice processor. This dependency informs those elements, such as the load store unit (222), that the load IOP should not be executed until the execution of the store IOP has completed. The hazard table may be stored in the instruction fetch unit and implemented in a variety of data structures. For example, the hazard table may be a direct lookup table, a hash table, an array, or any other type of data structure that provides one value keyed to another value.

An ITAG is an instruction identifier. Each ITAG tracks an internal operation from decode to completion. Each internal operation may be assigned an ITAG by an ITAG assignment unit, which assigns ITAGs sequentially to internal operations (IOPs) before the internal operations are transmitted to a dispatch unit. IOPs are the result of decoding processor instructions, and each IOP is tracked using an ITAG. Processor instructions may be decoded into a single IOP or may be decoded into a plurality of IOPs.

The ITAG offset is an indicator of the prior IOP that the load IOP decoded from the instruction stored at the effective address should be made dependent upon. The ITAG offset may be a value that separates the ITAG for a load IOP and the ITAG for a store ITAG upon which the load ITAG is to be made dependent. For example, if the ITAG for a load IOP is “24” and the ITAG for a store IOP is “14”, then the ITAG offset may be “10”. The ITAG offset may include the ITAG of the prior IOP itself. For example, if the ITAG for a load IOP is “24” and the ITAG for a store IOP is “14”, then the ITAG offset may be “14” (the value of the ITAG for the store IOP).

The method of FIG. 4 also includes fetching (404), by an instruction fetch unit (300), a processor instruction from a memory location using the effective address. Fetching (404), by an instruction fetch unit (300), a processor instruction from a memory location using the effective address may be carried out by retrieving the next processor instruction stored in an instruction register or other memory location indicated by the effective address.

The method of FIG. 4 also includes determining (406) that the hazard table includes the entry for the effective address. Determining (406) that the hazard table includes the entry for the effective address may be carried out by performing a lookup in the hazard table using the effective address as a key. For example, the instruction may be fetched from an effective address of “326”. The value of the effective address (“326”) may then be used as a key for a lookup operation on the hazard table. If the hazard table has an entry for “326”, then the hazard table returns a value for the ITAG offset associated with that effective address value entry. If the hazard table does not have an entry for “326”, then the hazard table may return an ITAG value of null or “0” to the instruction fetch unit (300). The hazard table may also return an ITAG value of null or “0” to the instruction fetch unit (300) in the event that the ITAG offset received in the flush indication was null or “0”, or if the ITAG offset exceeds a threshold. Accordingly, a “0” or null entry may operate similar to a valid bit in flush indication and/or the hazard table entry. Alternatively, the flush indication and/or the hazard table entry may include a valid bit to indicate whether the contents of the ITAG offset are valid.

The method of FIG. 4 also includes retrieving (408), from the hazard table, the ITAG offset for the effective address. Retrieving (408), from the hazard table, the ITAG offset for the effective address may be carried out by reading the value returned from a lookup procedure using the effective address as a key. As in the example provided above, if the hazard table has an entry for “326”, then the hazard table returns a value (e.g., “14”) for the ITAG offset associated with that effective address value entry.

The method of FIG. 4 also includes identifying (410) a prior internal operation (IOP) using the ITAG offset. Identifying (410) a prior internal operation (TOP) using the ITAG offset may be carried out by obtaining an ITAG of the prior IOP based on the ITAG offset. This may include calculating the ITAG for the prior IOP using the ITAG offset and an ITAG for the load IOP. This may further include reading and/or converting the ITAG for the prior IOP using the ITAG offset. For example, if the ITAG offset includes the ITAG of the prior IOP, then the ITAG for the prior IOP is read from the ITAG offset. The ITAG of the prior IOP may be encoded in the ITAG offset such that the instruction fetch unit (300) may convert the ITAG offset into the ITAG of the prior IOP.

The prior IOP may be a store IOP that stores result data into memory read by the load IOP. For example, a load IOP may read result data from memory (such as L1 cache) placed in memory by a store IOP. The load IOP and store IOP may be part of a set of processor instructions that are executed multiple times. Further, the conditions under which the load IOP and store IOP are executed may cause the load IOP to read the memory before the store IOP has stored the result data in the memory (triggering the hazard and resulting in a flush). The prior IOP may be a store IOP whose delay against the load IOP causes the hazard.

Identifying (410) a prior IOP using the ITAG offset may not necessary identify the intended IOP. For example, the prior IOP may be intended to be a store IOP that stores result data in memory read by a load IOP decoded from the processor instruction. However, the calculations or processing of the ITAG offset may result in an ITAG value that is not the ITAG value that has been assigned to the store IOP (such as an IOP decoded before or after the store IOP). This may occur, for example, if one or more conditional branches were taken between the store TOP and the load TOP because of a different conditional outcome. This would cause the processor instructions that include the store and load to be refetched in a different order, and be assigned ITAGs with a different offset in subsequent decodings.

The method of FIG. 4 also includes decoding (412) the processor instruction into a load TOP with a dependency on the prior TOP. Decoding (412) the processor instruction into a load TOP with a dependency on the prior TOP may be carried out by converting the processor instruction into one or more IOPs, and assigning a dependency to the decoded load IOP.

The processor instruction may be decoded into multiple IOPs. In order to determine which of the decoded IOPs is the load TOP, the instruction fetch unit (300) may have knowledge of which of the decoded IOPs is the load TOP. This may be in the form of a table stored in the instruction fetch unit that informs the instruction decode logic (308) regarding which of the IOPs decoded is the load TOP. Alternatively, the instruction fetch unit (300) may assign the dependency to each decoded TOP.

The dependency on the prior TOP may be tracked using an ITAG for the load TOP and an ITAG for the prior TOP. For example, the issue queue of the load store slice (222) may include a field for the ITAG of IOPs upon which a store TOP is dependent. The load store slice (222) may then wait until the result data from the TOP associated with the ITAG is available before executing the load TOP stored in the issue queue.

As discussed above, the identified prior TOP may not be the store TOP that stores result data in memory read by a load TOP. If another TOP is identified, then the load TOP may be made dependent upon an TOP that may not be directly related to the execution of the load TOP. However, this may still provide a beneficial result, in that the load TOP may be delayed sufficiently by having to wait on the prior TOP that the store TOP is provided enough time to complete. Further, the store TOP may have already been executed before the load TOP is dispatched. Therefore, the instruction sequencer unit (240) may be configured to determine that the dependency has been met once the load TOP has been received.

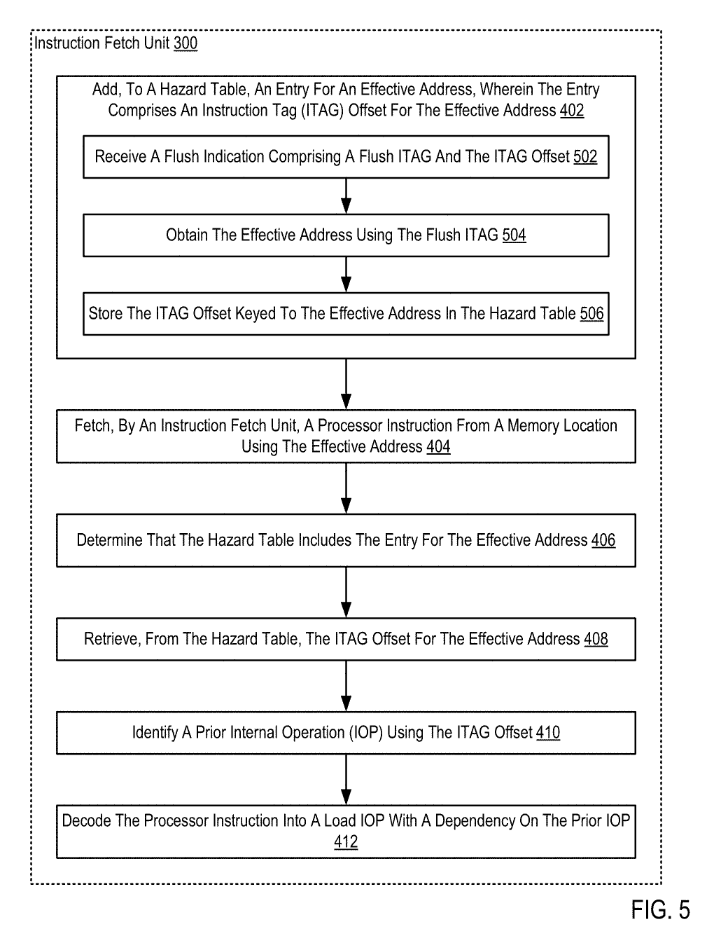

For further explanation, FIG. 5 sets forth a flow chart illustrating an exemplary method for hazard avoidance in a multi-slice processor according to embodiments of the present invention that includes adding (402), to a hazard table, an entry for an effective address, wherein the entry comprises an instruction tag (ITAG) offset for the effective address; fetching (404), by an instruction fetch unit (300), a processor instruction from a memory location using the effective address; determining (406) that the hazard table includes the entry for the effective address; retrieving (408), from the hazard table, the ITAG offset for the effective address; identifying (410) a prior internal operation (TOP) using the ITAG offset; and decoding (412) the processor instruction into a load TOP with a dependency on the prior TOP.

The method of FIG. 5 differs from the method of FIG. 4, however, in that adding (402), to a hazard table, an entry for an effective address, wherein the entry comprises an instruction tag (ITAG) offset for the effective address includes receiving (502) a flush indication comprising a flush ITAG and the ITAG offset; obtaining (504) the effective address using the flush ITAG; and storing (506) the ITAG offset keyed to the effective address in the hazard table.

Receiving (502) a flush indication comprising a flush ITAG and the ITAG offset may be carried out by a load store slice (222) detecting a hazard and flushing the hazard-causing TOP. The load store slice (222) may then notify the instruction fetch unit (300) of the flush and include the ITAG of the flushed TOP along with the ITAG offset (indicating the ITAG of the TOP whose delay triggered the flush).

The flush ITAG may identify a prior load TOP previously decoded from the processor instruction. Specifically, the same group of processor instructions may be fetched and executed multiple times in the course of executing code. Accordingly, the same processor instruction may be fetched and decoded multiple times. The flush ITAG may therefore be the ITAG previously assigned to a load TOP previously decoded from the processor instruction.

The ITAG offset may be transmitted from a load store slice (222) instead of the ITAG of the store TOP in order to reduce the size of the flush indication. For example, an ITAG may require 9 bits and an ITAG offset may require 6 bits. It would therefore be more efficient to transmit the ITAG offset and the ITAG of the load IOP instead of the ITAG for the store IOP and the ITAG for the load IOP.

Obtaining (504) the effective address using the flush ITAG may be carried out using an effective address table (EAT) and a processor instruction vector. The flush ITAG may be compared to rows of the EAT to determine an EAT row that includes the flush ITAG. The EAT row includes a range of effective addresses and the first ITAG assigned to the IOPs decoded from the range of effective addresses. The number of ITAGs assigned to the effective address range may be obtained using the processor instruction vector, and an effective address offset may be derived from the flush ITAG and the processor instruction vector. Finally, the effective address offset may be applied to the effective address range in the effective address row to obtain the effective address of the processor instruction for the flush ITAG.

The load store slice (222) may flush all IOPs after the store IOP or may just flush the IOPs after (and including) the load IOP that triggered the flush. If all IOPs following the store IOP are flushed, then the instruction fetch unit (300) may obtain the effective address of both the ITAG of the IOP following the store IOP and the ITAG of the load IOP. The effective address of the ITAG for the IOP following the store IOP is used to start refetching the instructions following the flush. The effective address of the ITAG for the load IOP (i.e., the flush ITAG) may be used to create the entry in the hazard table.

Storing (506) the ITAG offset keyed to the effective address in the hazard table may be carried out by creating an entry in the hazard table using the effective address as a key, and storing the ITAG offset in the entry.

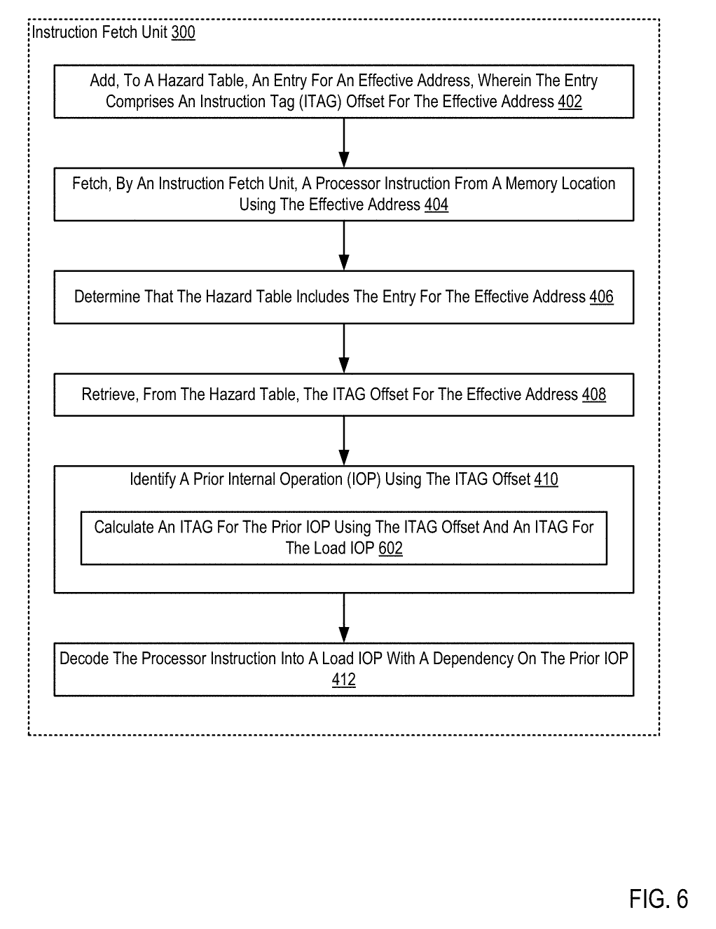

For further explanation, FIG. 6 sets forth a flow chart illustrating an exemplary method for hazard avoidance in a multi-slice processor according to embodiments of the present invention that includes adding (402), to a hazard table, an entry for an effective address, wherein the entry comprises an instruction tag (ITAG) offset for the effective address; fetching (404), by an instruction fetch unit (300), a processor instruction from a memory location using the effective address; determining (406) that the hazard table includes the entry for the effective address; retrieving (408), from the hazard table, the ITAG offset for the effective address; identifying (410) a prior internal operation (TOP) using the ITAG offset; and decoding (412) the processor instruction into a load IOP with a dependency on the prior IOP.

The method of FIG. 6 differs from the method of FIG. 4, however, in that identifying (410) a prior internal operation (IOP) using the ITAG offset includes calculating (602) an ITAG for the prior IOP using the ITAG offset and an ITAG for the load IOP. Calculating (602) an ITAG for the prior IOP using the ITAG offset and an ITAG for the load IOP may be carried out by subtracting the ITAG offset from the ITAG for the load IOP. ITAGs may be assigned sequentially, and the intended prior IOP may be assigned an ITAG that is separated from the ITAG for the load IOP by a value equal to the ITAG offset. For example, if the ITAG for the load IOP is “24”, and the ITAG offset is “10”, then the ITAG for the prior IOP may be calculated as “24−10”, which is “14”.

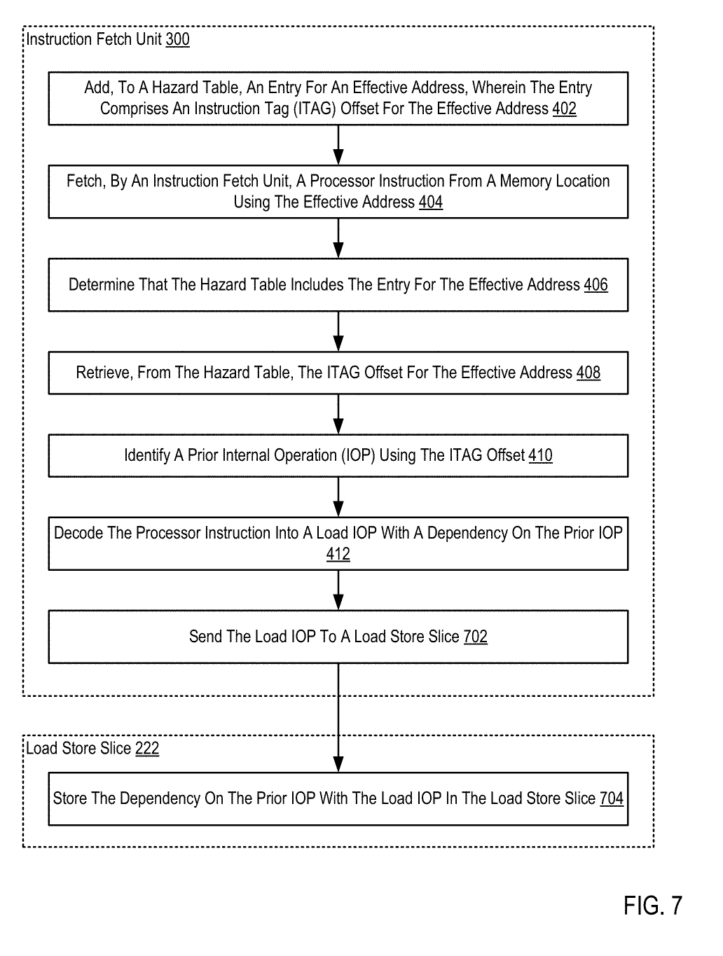

For further explanation, FIG. 7 sets forth a flow chart illustrating an exemplary method for hazard avoidance in a multi-slice processor according to embodiments of the present invention that includes adding (402), to a hazard table, an entry for an effective address, wherein the entry comprises an instruction tag (ITAG) offset for the effective address; fetching (404), by an instruction fetch unit (300), a processor instruction from a memory location using the effective address; determining (406) that the hazard table includes the entry for the effective address; retrieving (408), from the hazard table, the ITAG offset for the effective address; identifying (410) a prior internal operation (TOP) using the ITAG offset; and decoding (412) the processor instruction into a load IOP with a dependency on the prior IOP.

The method of FIG. 7 differs from the method of FIG. 4, however, in that the method of FIG. 7 further includes sending (702) the load IOP to a load store slice (222); and storing (704) the dependency on the prior IOP with the load IOP in the load store slice (222). Sending (702) the load IOP to a load store slice (222) may be carried out by transmitting the load IOP and ITAG for the load IOP to the issue queue of a load store slice (222).

Storing (704) the dependency on the prior TOP with the load TOP in the load store slice (222) may be carried out by storing the ITAG of the prior TOP with the load TOP and the ITAG of the load TOP in an issue queue of the load store slice (222).

The load store slice (222) may wait until the result data has been stored in memory before executing the load TOP. Specifically, the load store slice (222) may read the ITAG of the prior TOP and place the load TOP in a wait state until the result data stored by the store TOP is available or expected to be available.

Exemplary embodiments of the present invention are described largely in the context of a fully functional computer system for hazard avoidance in a multi-slice processor. Readers of skill in the art will recognize, however, that the present invention also may be embodied in a computer program product disposed upon computer readable storage media for use with any suitable data processing system. Such computer readable storage media may be any storage medium for machine-readable information, including magnetic media, optical media, or other suitable media. Examples of such media include magnetic disks in hard drives or diskettes, compact disks for optical drives, magnetic tape, and others as will occur to those of skill in the art. Persons skilled in the art will immediately recognize that any computer system having suitable programming means will be capable of executing the steps of the method of the invention as embodied in a computer program product. Persons skilled in the art will recognize also that, although some of the exemplary embodiments described in this specification are oriented to software installed and executing on computer hardware, nevertheless, alternative embodiments implemented as firmware or as hardware are well within the scope of the present invention.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

1-7. (canceled)

8. A multi-slice processor configured to carry out:
adding, to a hazard table, an entry for an effective address, wherein the entry comprises an instruction tag (ITAG) offset for the effective address;
fetching, by an instruction fetch unit, a processor instruction from a memory location using the effective address;
determining that the hazard table includes the entry for the effective address;
retrieving, from the hazard table, the ITAG offset for the effective address;
identifying a prior internal operation (TOP) using the ITAG offset; and
decoding the processor instruction into a load TOP with a dependency on the prior TOP.

9. The multi-slice processor of claim 8, wherein adding, to the hazard table, the entry for the effective address comprises:
receiving a flush indication comprising a flush ITAG and the ITAG offset;
obtaining the effective address using the flush ITAG; and
storing the ITAG offset keyed to the effective address in the hazard table.

10. The multi-slice processor of claim 9, wherein the flush ITAG identifies a prior load TOP previously decoded from the processor instruction.

11. The multi-slice processor of claim 8, wherein identifying the prior TOP using the ITAG offset comprises:
calculating an ITAG for the prior TOP using the ITAG offset and an ITAG for the load TOP.

12. The multi-slice processor of claim 8, further configured to carry out:
sending the load TOP to a load store slice; and
storing the dependency on the prior TOP with the load TOP in the load store slice.

13. The multi-slice processor of claim 8, wherein the prior TOP is a store TOP that stores result data into memory read by the load TOP.

14. The multi-slice processor of claim 8, wherein the dependency on the prior TOP is tracked using an ITAG for the load TOP and an ITAG for the prior TOP.

15. An apparatus comprising:
a multi-slice processor configured to carry out:
adding, to a hazard table, an entry for an effective address, wherein the entry comprises an instruction tag (ITAG) offset for the effective address;
fetching, by an instruction fetch unit, a processor instruction from a memory location using the effective address;
determining that the hazard table includes the entry for the effective address;
retrieving, from the hazard table, the ITAG offset for the effective address;
identifying a prior internal operation (TOP) using the ITAG offset; and
decoding the processor instruction into a load TOP with a dependency on the prior TOP.

16. The apparatus of claim 15, wherein adding, to the hazard table, the entry for the effective address comprises:
receiving a flush indication comprising a flush ITAG and the ITAG offset;
obtaining the effective address using the flush ITAG; and
storing the ITAG offset keyed to the effective address in the hazard table.

17. The apparatus of claim 16, wherein the flush ITAG identifies a prior load TOP previously decoded from the processor instruction.

18. The apparatus of claim 15, wherein identifying the prior TOP using the ITAG offset comprises:
calculating an ITAG for the prior IOP using the ITAG offset and an ITAG for the load IOP.

19. The apparatus of claim 15, wherein the multi-slice processor is further configured to carry out:
sending the load IOP to a load store slice; and
storing the dependency on the prior IOP with the load IOP in the load store slice.

20. The apparatus of claim 15, wherein the prior IOP is a store IOP that stores result data into memory read by the load IOP.
